(19) United States
(12) Patent Application Publication
(10) Pub. No.: US 2025/0267072 A1
(43) Pub. Date: Aug. 21, 2025

(54) SERVICE FLOW PERCEPTION METHOD AND APPARATUS FOR EDGE COMPUTING, AND ELECTRONIC DEVICE

(71) Applicant: BEIJING SMARTCHIP MICROELECTRONICS TECHNOLOGY COMPANY LIMITED, Beijing (CN)

(72) Inventors: Yan Zhen, Beijing (CN); Huifeng Bai, Beijing (CN); Chao Huo, Beijing (CN); Hao Liu, Beijing (CN); Zhijie Huang, Beijing (CN); Libin Zheng, Beijing (CN); Riliang Liu, Beijing (CN); Xuqiang Wang, Beijing (CN); Yinzhang Cheng, Beijing (CN); Jie Zhang, Beijing (CN); Rentao Gu, Beijing (CN); Yuanliang Fan, Beijing (CN); Bo Yan, Beijing (CN); Ganghong Zhang, Beijing (CN); Zhibin Yin, Beijing (CN)

(21) Appl. No.: 19/203,168

(22) Filed: May 9, 2025

Related U.S. Application Data
(63) Continuation-in-part of application No. PCT/CN2024/134753, filed on Nov. 27, 2024.

(30) Foreign Application Priority Data
Feb. 7, 2024 (CN) 202410172653.1

(51) Int. Cl. H04L 41/14; H04L 43/022

(52) U.S. Cl. CPC H04L 41/145; H04L 43/022

(57) ABSTRACT

Provided are a service flow perception method and apparatus for edge computing, and an electronic device. The method includes: obtaining a service flow; performing feature extraction on the service flow to obtain a feature vector; inputting the feature vector into a service type perception model to obtain a service type perception result; and allocating a corresponding computing power resource and communication resource to the service flow based on the service type perception result, where an output value of a fast gated recurrent unit is calculated based on an update gate and an intermediate state, the intermediate state and the update gate are calculated based on an output value of a hidden layer of a previous fast gated recurrent unit and a feature parameter input into a current fast gated recurrent unit, and the service type perception model is obtained through training.

### CROSS REFERENCE TO RELATED APPLICATIONS

The present application is a Continuation-In-Part Application of PCT Application No. PCT/CN 2024/134753 filed on Nov. 27, 2024, which claims the benefit of Chinese Patent Application No. 202410172653.1 filed on Feb. 7, 2024. All the above are hereby incorporated by reference in their entirety.

### TECHNICAL FIELD

The present disclosure relates to the technical field of artificial intelligence, and specifically, to a service flow perception method for edge computing, a service flow perception apparatus for edge computing, and an electronic device.

### BACKGROUND

Edge computing of the Power Distribution Internet of Things (PDIoT) must meet high real-time performance, high efficiency, and high accuracy required for mass access of diversified and differentiated power services. With increasingly complex and diverse services faced by the PDIoT, in order to achieve better quality of service (QOS), recognizing a connected service and optimizing a support capability of differentiated service processing are prerequisites for improving QoS of many services in the PDIoT.

A service perception and recognition technology is a machine learning based method evolved from an early port recognition method and deep packet/flow inspection method. The port recognition method often has low recognition accuracy due to a change of a port number. In order to address limitations of the port recognition method, a new approach for service flow recognition has been provided based on deep packet/flow inspection methods for an application layer, a payload, and the like. The deep packet/flow inspection method detects content of a data packet for classification recognition, and performs classification processing based on a feature pattern of a known service flow. The deep packet/flow inspection method has advantages of a high recognition accuracy and a small service granularity. However, increasingly diverse service protocols of the PDIoT lead to high complexity for real-time classification calculation, and even a longer recognition processing delay for some encrypted service data packets. As a result, the deep packet/flow inspection method is greatly limited in connecting and processing a heterogeneous multi-source service of an edge computing device. However, a traditional neural network algorithm has lots of calculations to some extent, which makes it difficult to achieve a fast calculation for service classification recognition under an edge computing condition with limited computing power.

Therefore, how to realize low-complexity service perception oriented to edge computing has become a problem to be urgently solved.

### SUMMARY

An objective of embodiments of the present disclosure is to provide a service flow perception method for edge computing, a service flow perception apparatus for edge computing, and an electronic device, so as to solve a defect that an existing method cannot realize low-complexity service perception oriented to edge computing.

To achieve the foregoing objective, the embodiments of the present disclosure provide a service flow perception method for edge computing, including:

obtaining a service flow;

performing feature extraction on the service flow to obtain a feature vector, where the feature vector includes a plurality of feature parameters of the service flow;

inputting the feature vector into a service type perception model to obtain a service type perception result that is of the service flow and output by the service type perception model; and

allocating a corresponding computing power resource and communication resource to the service flow based on the service type perception result, where

the service type perception model performs service type perception on all the feature parameters of the service flow based on a plurality of fast gated recurrent units, an output value of the fast gated recurrent unit is calculated based on an update gate and an intermediate state of the fast gated recurrent unit, the intermediate state and the update gate of the fast gated recurrent unit each are calculated based on an output value of a hidden layer of a previous fast gated recurrent unit and a feature parameter input into a current fast gated recurrent unit, and the service type perception model is obtained through training based on a sample feature vector obtained by performing the feature extraction on a sample service flow.

Optionally, the service type perception model includes an input layer, a fast gated recurrent unit layer, and an output layer;

the fast gated recurrent unit layer includes a plurality of fast gated recurrent unit groups corresponding to a quantity of feature parameters of the service flow, where each fast gated recurrent unit group includes a plurality of cascaded fast gated recurrent units; and

an intermediate state and an update gate of each fast gated recurrent unit each are calculated based on an output value of a hidden layer of a previous fast gated recurrent unit, a feature parameter input into the current fast gated recurrent unit, a weight coefficient of the update gate of the current fast gated recurrent unit, a weight coefficient of the intermediate state of the current fast gated recurrent unit, and an offset.

Optionally, the update gate, the intermediate state, and an output value of each fast gated recurrent unit are represented by following formulas:

$$\begin{matrix}{z}_{k} = σ ( {U}_{z} {y}_{k - 1} + {W}_{y} {x}_{k} + {b}_{z} ) ; \\ {y}_{k}^{′} = tanh ( {U}_{z} {y}_{k - 1} + {W}_{y} {x}_{k} + {b}_{z} ) ; \\ {y}_{k} = ( 1 - {z}_{k} ) ⊙ {y}_{k - 1} + {z}_{k} ⊙ {y}_{k}^{′} ;\end{matrix}$$

where yₖ₋₁ represents the output value of the hidden layer of the previous fast gated recurrent unit, xₖ represents the feature parameter that is of the service flow and input into the current fast gated recurrent unit, σ represents a sigmoid function, tanh represents a tanh function, zₖ represents the update gate of the fast gated recurrent unit, y′ₖ represents an updated intermediate state, yₖ represents the output value of the current fast gated recurrent unit, U_{z} represents the weight coefficient of the update gate, W_{y} represents the weight coefficient of the intermediate state, b_{z} represents the offset, and k represents a k^{th} service flow.

Optionally, the service type perception model is obtained through training based on a following step:

repeatedly performing following steps until a difference between two adjacent output values calculated by the service type perception model is less than a specified threshold:

obtaining the sample service flow;

performing the feature extraction on the sample service flow to obtain the sample feature vector;

inputting the sample feature vector into the service type perception model to obtain a sample service type perception result; and

calculating a difference between the sample service type perception result and an output value previously calculated by the service type perception model; where

an output value of the fast gated recurrent unit of the service type perception model after the sample feature vector is continuously input for n times is represented by following formulas:

$$\begin{matrix}{y}_{k + 1}^{( n )} = ( 1 - {z}_{k + 1}^{( n - 1 )} ) ⊙ {y}_{k}^{( n )} + {z}_{k + 1}^{( n - 1 )} ⊙ {y}_{k + 1}^{′ ( n )} ; \\ {y}_{k + 1}^{( 0 )} = 0 ;\end{matrix}$$

where yₖ₊₁⁽ⁿ⁾ represents an output value of the fast gated recurrent unit after a (k+1)^{th} sample feature vector is continuously input for the n times; zₖ₊₁⁽ⁿ⁻¹⁾ represents an update gate of the fast gated recurrent unit after the (k+1)^{th} sample feature vector is continuously input for n−1 times; represents an output value of the fast gated recurrent unit after a k^{th} sample feature vector is continuously input for the n times; y′ₖ₊₁⁽ⁿ⁾ represents an intermediate state of the fast gated recurrent unit after the (k+1)^{th} sample feature vector is continuously input for the n times; and yₖ₊₁⁽⁰⁾ represents an initial output value of the fast gated recurrent unit at a 0^{th} input of the (k+1)^{th} sample feature vector.

Optionally, the performing feature extraction on the service flow to obtain a feature vector includes:

extracting a specified quantity of data packets from the service flow as a service sub-flow; and

performing the feature extraction on the service sub-flow to obtain a feature vector, where the feature vector includes a plurality of feature parameters of the service sub-flow.

Optionally, the feature parameters include at least two of a data amount of a maximum data packet in the service sub-flow, a data amount of a minimum data packet in the service sub-flow, an average data amount of data packets in the service sub-flow, average arrival time of the data packets in the service sub-flow, an average arrival time interval of the data packets in the service sub-flow, a total data amount of the service sub-flow, duration of the service sub-flow, and a flag bit of the service sub-flow.

According to another aspect, the embodiments of the present disclosure further provide a service flow perception apparatus for edge computing, including:

a service access module configured to obtain a service flow;

a service feature extraction module configured to perform feature extraction on the service flow to obtain a feature vector, where the feature vector includes a plurality of feature parameters of the service flow;

a service recognition module configured to input the feature vector into a service type perception model to obtain a service type perception result that is of the service flow and output by the service type perception model; and

a service flow scheduling module configured to allocate a corresponding computing power resource and communication resource to the service flow based on the service type perception result, where

the service type perception model performs service type perception on all the feature parameters of the service flow based on a plurality of fast gated recurrent units, an output value of the fast gated recurrent unit is calculated based on an update gate and an intermediate state of the fast gated recurrent unit, the intermediate state and the update gate of the fast gated recurrent unit each are calculated based on an output value of a hidden layer of a previous fast gated recurrent unit and a feature parameter input into a current fast gated recurrent unit, and the service type perception model is obtained through training based on a sample feature vector obtained by performing the feature extraction on a sample service flow.

Optionally, the service type perception model includes an input layer, a fast gated recurrent unit layer, and an output layer;

the fast gated recurrent unit layer includes a plurality of fast gated recurrent unit groups corresponding to a quantity of feature parameters of the service flow, where each fast gated recurrent unit group includes a plurality of cascaded fast gated recurrent units; and

an intermediate state and an update gate of each fast gated recurrent units each are calculated based on the output value of the hidden layer of the previous fast gated recurrent unit, a feature parameter input into the current fast gated recurrent unit, a weight coefficient of the update gate of the current fast gated recurrent unit, a weight coefficient of the intermediate state of the current fast gated recurrent unit, and an offset.

Optionally, the update gate, the intermediate state, and an output value of each fast gated recurrent unit are represented by following formulas:

$$\begin{matrix}{z}_{k} = σ ( {U}_{z} {y}_{k - 1} + {W}_{y} {x}_{k} + {b}_{z} ) ; \\ {y}_{k}^{′} = tanh ( {U}_{z} {y}_{k - 1} + {W}_{y} {x}_{k} + {b}_{z} ) ; \\ {y}_{k} = ( 1 - {z}_{k} ) ⊙ {y}_{k - 1} + {z}_{k} ⊙ {y}_{k}^{′} ;\end{matrix}$$

where yₖ₋₁ represents the output value of the hidden layer of the previous fast gated recurrent unit, xₖ represents the feature parameter that is of the service flow and input into the current fast gated recurrent unit, σ represents a sigmoid function, tanh represents a tanh function, zₖ represents the update gate of the fast gated recurrent unit, y′ₖ represents an updated intermediate state, yₖ represents the output value of the current fast gated recurrent unit, U_{z} represents the weight coefficient of the update gate, W_{y} represents the weight coefficient of the intermediate state, b_{z} represents the offset, and k represents a k^{th} service flow.

Optionally, the service flow perception apparatus for edge computing further includes a service perception training module, where the service perception training module performs training based on a following step to obtain the service type perception model:

repeatedly performing following steps until a difference between two adjacent output values calculated by the service type perception model is less than a specified threshold:

obtaining the sample service flow;

performing the feature extraction on the sample service flow to obtain the sample feature vector;

inputting the sample feature vector into the service type perception model to obtain a sample service type perception result; and

calculating a difference between the sample service type perception result and an output value previously calculated by the service type perception model; wherein

an output value of the fast gated recurrent unit of the service type perception model after the sample feature vector is continuously input for n times is represented by following formulas:

$$\begin{matrix}{y}_{k + 1}^{( n )} = ( 1 - {z}_{k + 1}^{( n - 1 )} ) ⊙ {y}_{k}^{( n )} + {z}_{k + 1}^{( n - 1 )} ⊙ {y}_{k + 1}^{′ ( n )} ; \\ {y}_{k + 1}^{( 0 )} = 0 ;\end{matrix}$$

where yₖ₊₁⁽ⁿ⁾ represents an output value of the fast gated recurrent unit after a (k+1)^{th} sample feature vector is continuously input for the n times; zₖ₊₁⁽ⁿ⁻¹⁾ represents an update gate of the fast gated recurrent unit after the (k+1)^{th} sample feature vector is continuously input for n−1 times; represents an output value of the fast gated recurrent unit after a k^{th} sample feature vector is continuously input for the n times; y′ₖ₊₁⁽ⁿ⁾ represents an intermediate state of the fast gated recurrent unit after the (k+1)^{th} sample feature vector is continuously input for the n times; and yₖ₊₁⁽⁰⁾ represents an initial output value of the fast gated recurrent unit at a 0^{th} input of the (k+1)^{th} sample feature vector.

Optionally, the performing feature extraction on the service flow to obtain a feature vector includes:

extracting a specified quantity of data packets from the service flow as a service sub-flow; and

performing the feature extraction on the service sub-flow to obtain a feature vector, where the feature vector includes a plurality of feature parameters of the service sub-flow.

Optionally, the feature parameters include at least two of a data amount of a maximum data packet in the service sub-flow, a data amount of a minimum data packet in the service sub-flow, an average data amount of data packets in the service sub-flow, average arrival time of the data packets in the service sub-flow, an average arrival time interval of the data packets in the service sub-flow, a total data amount of the service sub-flow, duration of the service sub-flow, and a flag bit of the service sub-flow.

According to another aspect, the present disclosure further includes an electronic device, including a memory, a processor, and a computer program stored in the memory and operable on the processor, where the processor executes the computer program to implement the above service flow perception method for edge computing.

According to another aspect, the present disclosure further provides a machine-readable storage medium storing a computer program thereon, where the computer program is executed by a processor to implement the above service flow perception method for edge computing.

According to the above technical solutions, the service type perception model in the embodiments of the present disclosure performs the service type perception on all the feature parameters of the service flow based on the fast gated recurrent units, and the output value of the fast gated recurrent unit is calculated based on the update gate and the intermediate state of the fast gated recurrent unit. The intermediate state and the update gate each are calculated based on the output value of the hidden layer of the previous fast gated recurrent unit and the feature parameter input into the current fast gated recurrent unit. Therefore, the fast gated recurrent unit in the embodiments of the present disclosure does not calculate a reset gate in a traditional gated recurrent unit. Through a structure of a lightweight fast gated recurrent unit, calculation complexity is reduced when the service type perception is performed on all the feature parameters of the service flow, thereby speeding up service classification recognition in edge computing.

Other features and advantages of embodiments of the present disclosure are described in detail in the subsequent specific implementation part.

### BRIEF DESCRIPTION OF THE DRAWINGS

The accompanying drawings are provided for further understanding of the embodiments of the present disclosure, and constitute a part of the specification. The accompanying drawings and the following specific implementations are intended to explain the embodiments of the present disclosure, rather than to limit the embodiments of the present disclosure. In the accompanying drawings:

FIG. 1 is a schematic flowchart of a service flow perception method for edge computing according to the present disclosure;

FIG. 2 is a schematic structural diagram of a service type perception model according to the present disclosure;

FIG. 3 is a schematic structural diagram of a fast gated recurrent unit according to the present disclosure;

FIG. 4 is a first schematic structural diagram of a service flow perception apparatus for edge computing according to the present disclosure;

FIG. 5 is a second schematic structural diagram of a service flow perception apparatus for edge computing according to the present disclosure; and

FIG. 6 is a structural schematic diagram of an electronic device according to the present disclosure.

### DETAILED DESCRIPTION

Specific implementations of the embodiments of the present disclosure are described in detail below with reference to the accompanying drawings. It should be understood that the specific implementations described herein are merely intended to illustrate and interpret the embodiments of the present disclosure, rather than to limit the embodiments of the present disclosure.

### Method Embodiment

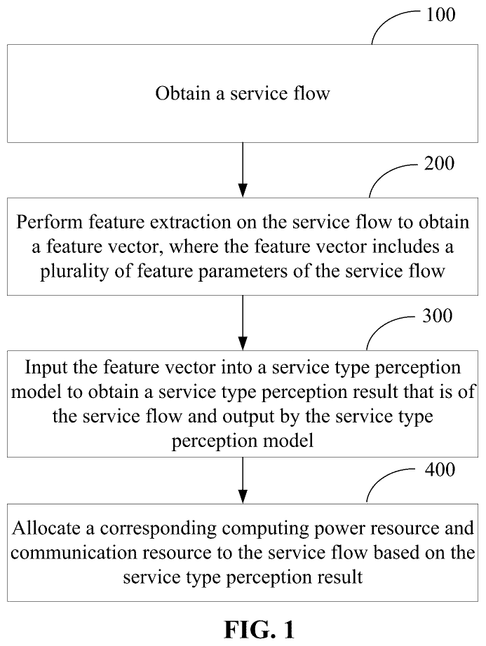

Referring to FIG. 1, an embodiment of the present disclosure provides a service flow perception method for edge computing, including the following steps:

Step 100: Obtain a service flow.

An electronic device for edge computing obtains the service flow. The service flow may be data flows of a plurality of services, such as electricity consumption information collection data, power distribution monitoring data, or sensor reporting data.

Step 200: Perform feature extraction on the service flow to obtain a feature vector, where the feature vector includes a plurality of feature parameters of the service flow.

The electronic device performs the feature extraction on the service flow to obtain the feature vector. The feature vector includes the feature parameters of the service flow. In an embodiment, in order to improve a recognition speed of the service flow, some data (namely a service sub-flow) in the service flow can be extracted for the feature extraction to obtain the feature vector. In other words, the performing feature extraction on the service flow to obtain a feature vector in the step 200 includes the following sub-steps:

Step 210: Extract a specified quantity of data packets from the service flow as the service sub-flow.

Step 220: Perform the feature extraction on the service sub-flow to obtain a feature vector.

For example, the electronic device can extract the first five data packets from the service flow to form the service sub-flow, and perform statistical feature parameter extraction on these five data packets to obtain the feature vector. The feature vector includes a plurality of feature parameters of the service sub-flow. The feature parameters include at least two of a data amount of a maximum data packet in the service sub-flow, a data amount of a minimum data packet in the service sub-flow, an average data amount of data packets in the service sub-flow, average arrival time of the data packets in the service sub-flow, an average arrival time interval of the data packets in the service sub-flow, a total data amount of the service sub-flow, duration of the service sub-flow, and a flag bit of the service sub-flow.

In order to comprehensively perform the feature extraction on the service sub-flow and improve accuracy of performing service type perception on the service sub-flow, in an embodiment, the feature parameters in the feature vector include: the data amount x₁ of the maximum data packet in the service sub-flow, the data amount x₂ of the minimum data packet in the service sub-flow, the average data amount x₃ of the data packets in the service sub-flow, the average arrival time x₄ of the data packets in the service sub-flow, the average arrival time interval x₅ of the data packets in the service sub-flow, the total data amount x₆ of the service sub-flow, the duration x₇ of the service sub-flow, and the flag bit of the service sub-flow x₈. The feature vector Xᵢ of the service sub-flow is expressed by a following formula:

$${X}_{i} = \{ {x}_{1} , {x}_{2} , … , {x}_{7} , {x}_{8} \} .$$

Step 300: Input the feature vector into a service type perception model to obtain a service type perception result that is of the service flow and output by the service type perception model.

The electronic device inputs the feature vector into the service type perception model to obtain the service type perception result that is of the service flow and output by the service type perception model. The service type perception model performs the service type perception on all the feature parameters of the service flow based on a plurality of fast gated recurrent units, and an output value of the fast gated recurrent unit is calculated based on an update gate and an intermediate state of the fast gated recurrent unit. The intermediate state and the update gate of the fast gated recurrent unit each are calculated based on an output value of a hidden layer of a previous fast gated recurrent unit and a feature parameter input into a current fast gated recurrent unit. The service type perception model is obtained through training based on a sample feature vector obtained by performing the feature extraction on a sample service flow.

It should be noted that an input value of the fast gated recurrent unit is not a time series parameter, but a feature parameter of the service sub-flow (in other words, the feature parameter of the service sub-flow does not have a temporal sequence characteristic).

Step 400: Allocate a corresponding computing power resource and communication resource to the service flow based on the service type perception result.

The electronic device allocates the corresponding computing power resource and communication resource to the service flow based on the service type perception result. That is, the electronic device controls and schedules a service flow queue based on the service type perception result, and allocates computing power resources and communication resources of software and hardware to the service flow queue, to recognize a connected service flow and optimize a support capability of differentiated service processing.

After the corresponding computing power resource and communication resource are allocated, the electronic device for edge computing uses the allocated computing power resource and communication resource to perform a calculation operation on the service flow, and a power system executes a power distribution task based on a result of the calculation operation.

The service type perception model in this embodiment of the present disclosure performs the service type perception on all the feature parameters of the service flow based on the fast gated recurrent units, and the output value of the fast gated recurrent unit is calculated based on the update gate and the intermediate state. The intermediate state and the update gate each are calculated based on the output value of the hidden layer of the previous fast gated recurrent unit and the feature parameter input into the current fast gated recurrent unit. Therefore, the fast gated recurrent unit in this embodiment of the present disclosure does not calculate a reset gate in a traditional gated recurrent unit. Through a structure of a lightweight fast gated recurrent unit, calculation complexity is reduced when the service type perception is performed on all the feature parameters of the service flow, thereby speeding up service classification recognition in the edge computing.

In other aspects of this embodiment of the present disclosure, the service type perception model includes an input layer, a fast gated recurrent unit layer, and an output layer. The input layer is configured to input a main feature parameter of the service sub-flow. In an embodiment, the input layer is configured to input eight feature parameters of the service sub-flow. That is, the input layer is configured to input the data amount x₁ of the maximum data packet in the service sub-flow, the data amount x₂ of the minimum data packet in the service sub-flow, the average data amount x₃ of the data packets in the service sub-flow, the average arrival time x₄ of the data packets in the service sub-flow, the average arrival time interval x₅ of the data packets in the service sub-flow, the total data amount x₆ of the service sub-flow, the duration x₇ of the service sub-flow, and the flag bit of the service sub-flow x₈. The output layer uses a SoftMax classification function to obtain the service type perception result from data output by the fast gated recurrent unit layer.

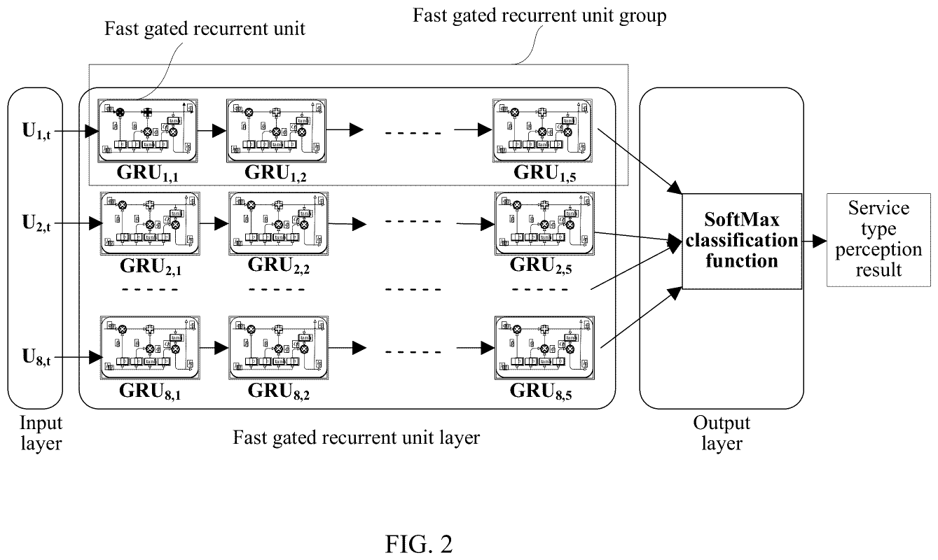

The fast gated recurrent unit layer includes a plurality of fast gated recurrent unit groups corresponding to a quantity of feature parameters of the service flow. For example, referring to FIG. 2, when the feature vector has the eight feature parameters of the service sub-flow, the fast gated recurrent unit layer includes eight fast gated recurrent unit groups. Each fast gated recurrent unit group includes a plurality of cascaded fast gated recurrent units. For example, in an embodiment, each fast gated recurrent unit group includes five cascaded fast gated recurrent units.

An intermediate state and an update gate of each fast gated recurrent unit each are calculated based on an output value of a hidden layer of a previous fast gated recurrent unit, a feature parameter input into the current fast gated recurrent unit, a weight coefficient of the update gate of the current fast gated recurrent unit, a weight coefficient of the intermediate state of the current fast gated recurrent unit, and an offset. The input value of the fast gated recurrent unit in this embodiment of the present disclosure is not the time series parameter, but the feature parameter of the service sub-flow (in other words, the feature parameter of the service sub-flow does not have the temporal sequence characteristic). The service type perception model in this embodiment of the present disclosure performs the service type perception on all the feature parameters of the service flow based on the fast gated recurrent unit groups corresponding to the quantity of feature parameters of the service flow. The fast gated recurrent unit in this embodiment does not calculate the reset gate in the traditional gated recurrent unit. Through the structure of the lightweight fast gated recurrent unit, calculation complexity is reduced when the service type perception is performed on the feature parameters of the service sub-flow, thereby speeding up the service classification recognition in the edge computing.

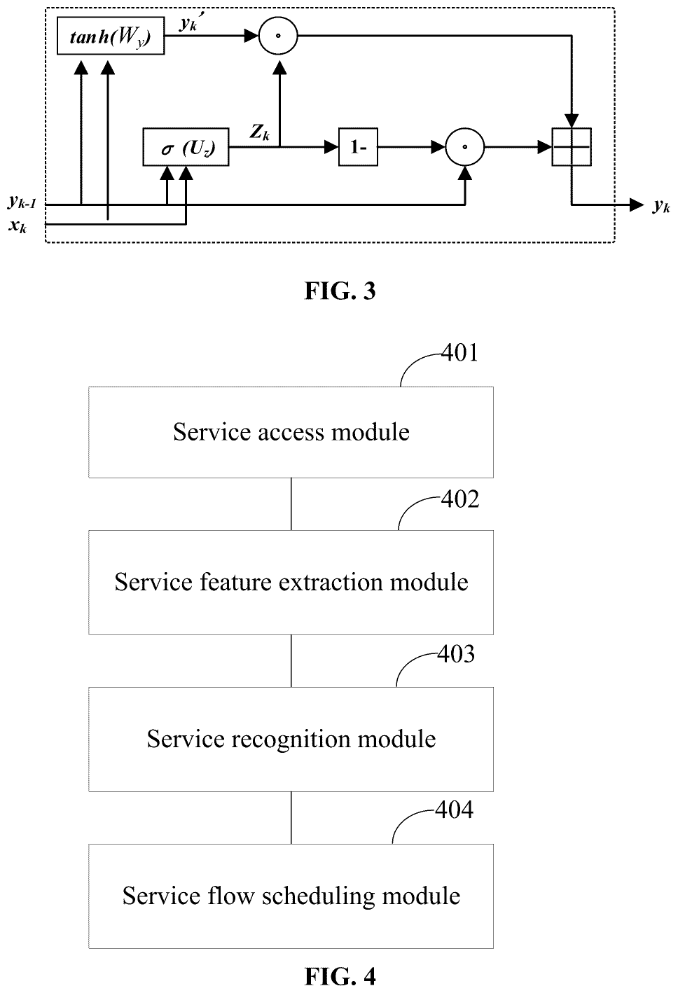

In other aspects of this embodiment of the present disclosure, referring to FIG. 3, the update gate, the intermediate state, and an output value of each fast gated recurrent unit are represented by following formulas:

$$\begin{matrix}{z}_{k} = σ ( {U}_{z} {y}_{k - 1} + {W}_{y} {x}_{k} + {b}_{z} ) ; \\ {y}_{k}^{′} = tanh ( {U}_{z} {y}_{k - 1} + {W}_{y} {x}_{k} + {b}_{z} ) ; \\ {y}_{k} = ( 1 - {z}_{k} ) ⊙ {y}_{k - 1} + {z}_{k} ⊙ {y}_{k}^{′} ;\end{matrix}$$

where yₖ₋₁ represents the output value of the hidden layer of the previous fast gated recurrent unit, xₖ represents the feature parameter that is of the service flow and input into the current fast gated recurrent unit, σ represents a sigmoid function, tanh represents a tanh function, zₖ represents the update gate of the fast gated recurrent unit, y′ₖ represents an updated intermediate state, yₖ represents the output value of the current fast gated recurrent unit, U_{z} represents the weight coefficient of the update gate, W_{y} represents the weight coefficient of the intermediate state, b_{z} represents the offset, and k represents a k^{th} service flow.

Compared with the traditional gated recurrent unit that uses the time series parameter in the input value, the fast gated recurrent unit in this embodiment of the present disclosure uses the feature parameter of the service sub-flow as an input, and the feature parameter of the service sub-flow omits the calculation of the reset gate in the traditional gated recurrent unit. Through the structure of the lightweight fast gated recurrent unit, the calculation complexity is reduced when the service type perception is performed on the feature parameters of the service sub-flow, thereby speeding up the service classification recognition in the edge computing.

In other aspects of this embodiment of the present disclosure, the service type perception model is obtained through training based on a following step:

repeatedly performing following steps until a difference between two adjacent output values calculated by the service type perception model is less than a specified threshold.

Step 10: Obtain the sample service flow.

The electronic device can obtain the sample service flow from a sample database module. The sample database module stores the sample service flow that represents a characteristic of the service flow. The sample database module provides a data sample for training the service type perception model, and obtains a data sample from the service type perception model to continuously enrich a database.

Step 20: Perform the feature extraction on the sample service flow to obtain the sample feature vector.

The electronic device performs the feature extraction on the sample service flow to obtain the sample feature vector. Specifically, the electronic device can extract a preset quantity of data packets from the sample service flow as a sample service sub-flow, and then perform the feature extraction on the sample service sub-flow to obtain a feature vector. For example, the electronic device can extract the first five data packets from the sample service flow to form the sample service sub-flow, and perform the statistical feature parameter extraction on these five data packets to obtain the sample feature vector. The sample feature vector includes a plurality of feature parameters of the sample service sub-flow. The feature parameters include at least two of a data amount of a maximum data packet in the sample service sub-flow, a data amount of a minimum data packet in the sample service sub-flow, an average data amount of data packets in the sample service sub-flow, average arrival time of the data packets in the sample service sub-flow, an average arrival time interval of the data packets in the sample service sub-flow, a total data amount of the sample service sub-flow, duration of the sample service sub-flow, and a flag bit of the sample service sub-flow.

In an embodiment, the feature parameters in the sample feature vector include the data amount of the maximum data packet in the sample service sub-flow, the data amount of the minimum data packet in the sample service sub-flow, the average data amount of the data packets in the sample service sub-flow, the average arrival time of the data packets in the sample service sub-flow, the average arrival time interval of the data packets in the sample service sub-flow, the total data amount of the sample service sub-flow, the duration of the sample service sub-flow, and the flag bit of the sample service sub-flow.

Step 30: Input the sample feature vector into the service type perception model to obtain a sample service type perception result.

Step 40: Calculate a difference between the sample service type perception result and an output value previously calculated by the service type perception model.

The electronic device inputs the sample feature vector into the service type perception model to obtain the sample service type perception result, and calculates the difference between the sample service perception result and the output value previously calculated by the service type perception model until the difference between the two adjacent output values calculated by the service type perception model is less than the specified threshold. In this case, the training of the service type perception model ends. That is, in this embodiment of the present disclosure, the sample service flow is continuously input from the sample database module until the output value of the fast gated recurrent unit tends to be stable, that is, the fast gated recurrent unit maintains an input sample unchanged in a classification learning process, and ultimately achieves a minimum difference between two adjacent iterative calculations.

It should be noted that the specified threshold may be set based on an actual situation, and a numerical value of the specified threshold is not specifically limited herein.

An output value of the fast gated recurrent unit of the service type perception model after the sample feature vector is continuously input for n times is represented by following formulas:

$$\begin{matrix}{y}_{k + 1}^{( n )} = ( 1 - {z}_{k + 1}^{( n - 1 )} ) ⊙ {y}_{k}^{( n )} + {z}_{k + 1}^{( n - 1 )} ⊙ {y}_{k + 1}^{′ ( n )} ; \\ {y}_{k + 1}^{( 0 )} = 0 ;\end{matrix}$$

where yₖ₊₁⁽ⁿ⁾ represents an output value of the fast gated recurrent unit after a (k+1)^{th} sample feature vector is continuously input for the n times; zₖ₊₁⁽ⁿ⁻¹⁾ represents an update gate of the fast gated recurrent unit after the (k+1)^{th} sample feature vector is continuously input for n−1 times; represents an output value of the fast gated recurrent unit after a k^{th} sample feature vector is continuously input for the n times; y′ₖ₊₁⁽ⁿ⁾ represents an intermediate state of the fast gated recurrent unit after the (k+1)^{th} sample feature vector is continuously input for the n times; and yₖ₊₁⁽⁰⁾ represents an initial output value of the fast gated recurrent unit at a 0^{th} input of the (k+1)^{th} sample feature vector.

The electronic device inputs the sample feature vector into the service type perception model to obtain the sample service type perception result, and calculates the difference between the sample service perception result and the output value previously calculated by the service type perception model until the difference between the two adjacent output values calculated by the service type perception model is less than the specified threshold. In this case, the training of the service type perception model ends. Therefore, in this embodiment of the present disclosure, a method for training the service type perception model based on the fast gated recurrent unit is constructed, thereby improving accuracy of the service type perception model in performing the service type perception.

The fast gated recurrent unit may be one or more processors, controllers or chips that each have a communications interface, can realize a communication protocol, and may further include a memory, a related interface and system transmission bus, and the like if necessary.

### Apparatus Embodiment

Referring to FIG. 4, according to another aspect, an embodiment of the present disclosure further provides a service flow perception apparatus for edge computing, including: a service access module 401 configured to obtain a service flow;

a service feature extraction module 402 configured to perform feature extraction on the service flow to obtain a feature vector, where the feature vector includes a plurality of feature parameters of the service flow;

a service recognition module 403 configured to input the feature vector into a service type perception model to obtain a service type perception result that is of the service flow and output by the service type perception model; and

a service flow scheduling module 404 configured to allocate a corresponding computing power resource and communication resource to the service flow based on the service type perception result.

The service type perception model performs service type perception on all the feature parameters of the service flow based on a plurality of fast gated recurrent units, an output value of the fast gated recurrent unit is calculated based on an update gate and an intermediate state of the fast gated recurrent unit, the intermediate state and the update gate of the fast gated recurrent unit each are calculated based on an output value of a hidden layer of a previous fast gated recurrent unit and a feature parameter input into a current fast gated recurrent unit, and the service type perception model is obtained through training based on a sample feature vector obtained by performing the feature extraction on a sample service flow.

Optionally, the service type perception model includes an input layer, a fast gated recurrent unit layer, and an output layer;

the fast gated recurrent unit layer includes a plurality of fast gated recurrent unit groups corresponding to a quantity of feature parameters of the service flow, where each fast gated recurrent unit group includes a plurality of cascaded fast gated recurrent units; and

an intermediate state and an update gate of each fast gated recurrent unit each are calculated based on an output value of a hidden layer of a previous fast gated recurrent unit, a feature parameter input into the current fast gated recurrent unit, a weight coefficient of the update gate of the current fast gated recurrent unit, a weight coefficient of the intermediate state of the current fast gated recurrent unit, and an offset.

Optionally, the update gate, the intermediate state, and an output value of each fast gated recurrent unit are represented by following formulas:

$$\begin{matrix}{z}_{k} = σ ( {U}_{z} {y}_{k - 1} + {W}_{y} {x}_{k} + {b}_{z} ) ; \\ {y}_{k}^{′} = tanh ( {U}_{z} {y}_{k - 1} + {W}_{y} {x}_{k} + {b}_{z} ) ; \\ {y}_{k} = ( 1 - {z}_{k} ) ⊙ {y}_{k - 1} + {z}_{k} ⊙ {y}_{k}^{′} ;\end{matrix}$$

where yₖ₋₁ represents the output value of the hidden layer of the previous fast gated recurrent unit, xₖ represents the feature parameter that is of the service flow and input into the current fast gated recurrent unit, σ represents a sigmoid function, tanh represents a tanh function, zₖ represents the update gate of the fast gated recurrent unit, y′ₖ represents an updated intermediate state, yₖ represents the output value of the current fast gated recurrent unit, U_{z} represents the weight coefficient of the update gate, W_{y} represents the weight coefficient of the intermediate state, b_{z} represents the offset, and k represents a k^{th} service flow.

Optionally, the service flow perception apparatus for edge computing further includes a service perception training module 405. The service perception training module 405 performs training based on a following step to obtain the service type perception model:

repeatedly performing following steps until a difference between two adjacent output values calculated by the service type perception model is less than a specified threshold:

obtaining the sample service flow;

performing the feature extraction on the sample service flow to obtain the sample feature vector;

inputting the sample feature vector into the service type perception model to obtain a sample service type perception result; and

calculating a difference between the sample service type perception result and an output value previously calculated by the service type perception model.

An output value of the fast gated recurrent unit of the service type perception model after the sample feature vector is continuously input for n times is represented by following formulas:

$$\begin{matrix}{y}_{k + 1}^{( n )} = ( 1 - {z}_{k + 1}^{( n - 1 )} ) ⊙ {y}_{k}^{( n )} + {z}_{k + 1}^{( n - 1 )} ⊙ {y}_{k + 1}^{′ ( n )} ; \\ {y}_{k + 1}^{( 0 )} = 0 ;\end{matrix}$$

where yₖ₊₁⁽ⁿ⁾ represents an output value of the fast gated recurrent unit after a (k+1)^{th} sample feature vector is continuously input for the n times; zₖ₊₁⁽ⁿ⁻¹⁾ represents an update gate of the fast gated recurrent unit after the (k+1)^{th} sample feature vector is continuously input for n−1 times; represents an output value of the fast gated recurrent unit after a k^{th} sample feature vector is continuously input for the n times; y′ₖ₊₁⁽ⁿ⁾ represents an intermediate state of the fast gated recurrent unit after the (k+1)^{th} sample feature vector is continuously input for the n times; and yₖ₊₁⁽⁰⁾ represents an initial output value of the fast gated recurrent unit at a 0^{th} input of the (k+1)^{th} sample feature vector.

Optionally, the performing feature extraction on the service flow to obtain a feature vector includes:

extracting a specified quantity of data packets from the service flow as a service sub-flow; and

performing the feature extraction on the service sub-flow to obtain a feature vector, where the feature vector includes a plurality of feature parameters of the service sub-flow.

Optionally, the feature parameters include at least two of a data amount of a maximum data packet in the service sub-flow, a data amount of a minimum data packet in the service sub-flow, an average data amount of data packets in the service sub-flow, average arrival time of the data packets in the service sub-flow, an average arrival time interval of the data packets in the service sub-flow, a total data amount of the service sub-flow, duration of the service sub-flow, and a flag bit of the service sub-flow.

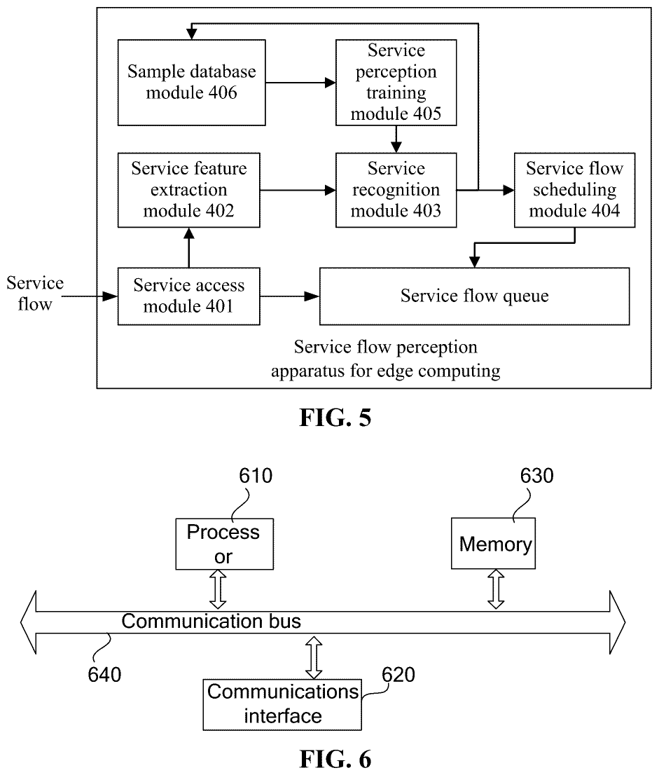

Referring to FIG. 5, the service flow perception apparatus for edge computing further includes a sample database module 406. The sample database module is configured to store the sample service flow that represents a characteristic of the service flow, provides a data sample for training the service type perception model, and obtains a data sample from the service recognition module to continuously enrich a database.

The service flow perception apparatus for edge computing includes a processor and a memory. The above service access module 401, service feature extraction module 402, service recognition module 403, service flow scheduling module 404, service perception training module 405, and sample database module 406 are all stored in the memory as program units, and the processor executes the above program units stored in the memory to achieve corresponding functions.

The processor contains a kernel, and the kernel calls a corresponding program unit from the memory. At least one kernel may be disposed.

The memory may include a non-persistent memory, a random access memory (RAM) and/or a non-volatile memory in a computer-readable medium, such as a read-only memory (ROM) or a flash RAM. The memory includes at least one storage chip.

FIG. 6 illustrates a schematic diagram of a physical structure of an electronic device. As shown in FIG. 6, the electronic device may include a processor 610, a communications interface 620, a memory 630, and a communication bus 640. The processor 610, the communications interface 620, and the memory 630 communicate with one another through the communication bus 640. The processor 610 can call a logic instruction in the memory 630 to execute a service flow perception method for edge computing. The service flow perception method includes: obtaining a service flow; performing feature extraction on the service flow to obtain a feature vector, where the feature vector includes a plurality of feature parameters of the service flow; inputting the feature vector into a service type perception model to obtain a service type perception result that is of the service flow and output by the service type perception model; and allocating a corresponding computing power resource and communication resource to the service flow based on the service type perception result. The service type perception model performs service type perception on all the feature parameters of the service flow based on a plurality of fast gated recurrent units. An output value of the fast gated recurrent unit is calculated based on an update gate and an intermediate state of the fast gated recurrent unit, and the intermediate state and the update gate of the fast gated recurrent unit each are calculated based on an output value of a hidden layer of a previous fast gated recurrent unit and a feature parameter input into a current fast gated recurrent unit. The service type perception model is obtained through training based on a sample feature vector obtained by performing the feature extraction on a sample service flow.

Besides, the logic instruction in the memory 630 may be implemented as a software function unit and be stored in a computer-readable storage medium when sold or used as a separate product. Based on such an understanding, the technical solutions of the present disclosure essentially or the part contributing to the prior art or part of the technical solutions may be embodied in a form of a software product. The computer software product is stored in a storage medium, and includes several instructions for enabling a computer device (which may be a personal computer, a server, a network device, or the like) to perform all or some steps of the methods described in the embodiments of the present disclosure. The storage medium includes any medium that can store program code, such as a universal serial bus (USB) flash disk, a mobile hard disk, a ROM, a RAM, a magnetic disk, or an optical disk.

According to another aspect, the present disclosure further provides a machine-readable storage medium storing a computer program thereon. The computer program is executed by a processor to execute a service flow perception method for edge computing. The service flow perception method includes: obtaining a service flow; performing feature extraction on the service flow to obtain a feature vector, where the feature vector includes a plurality of feature parameters of the service flow; inputting the feature vector into a service type perception model to obtain a service type perception result that is of the service flow and output by the service type perception model; and allocating a corresponding computing power resource and communication resource to the service flow based on the service type perception result. The service type perception model performs service type perception on all the feature parameters of the service flow based on a plurality of fast gated recurrent units. An output value of the fast gated recurrent unit is calculated based on an update gate and an intermediate state of the fast gated recurrent unit, and the intermediate state and the update gate of the fast gated recurrent unit each are calculated based on an output value of a hidden layer of a previous fast gated recurrent unit and a feature parameter input into a current fast gated recurrent unit. The service type perception model is obtained through training based on a sample feature vector obtained by performing the feature extraction on a sample service flow.

The apparatus embodiments described above are merely schematic. A unit described as a separate component may or may not be physically separated, and a component displayed as a unit may or may not be a physical unit, that is, the component may be located at one place, or distributed on a plurality of network units. Some or all of the modules may be selected based on actual needs to achieve the objectives of the solutions of the embodiments. A person of ordinary skill in the art can understand and implement the embodiments without creative efforts.

Through the description of the foregoing implementations, a person skilled in the art can clearly understand that the implementations may be implemented by means of software plus a necessary universal hardware platform, or certainly, may be implemented by hardware. Based on such an understanding, the foregoing technical solutions essentially or the part contributing to the prior art may be embodied in a form of a software product. The computer software product may be stored in a computer-readable storage medium, such as a ROM/RAM, a magnetic disk, or an optical disk, and includes several instructions for enabling a computer device (which may be a personal computer, a server, a network device, or the like) to execute the methods described in the embodiments or some of the embodiments.

Finally, it should be noted that the foregoing embodiments are only intended to illustrate, but not to limit, the technical solutions of the present disclosure. Although the present disclosure has been described in detail with reference to the foregoing embodiments, those of ordinary skill in the art should understand that: the technical solutions recorded in the foregoing embodiments may be still modified, or some of the technical features may be equivalently substituted; and these modifications or substitutions do not cause the essence of the corresponding technical solutions to depart from the spirit and scope of the technical solutions of the embodiments of the present disclosure.

1. A service flow perception method for edge computing, comprising:
obtaining a service flow;
performing feature extraction on the service flow to obtain a feature vector, wherein the feature vector comprises a plurality of feature parameters of the service flow;
inputting the feature vector into a service type perception model to obtain a service type perception result that is of the service flow and output by the service type perception model; and
allocating a corresponding computing power resource and communication resource to the service flow based on the service type perception result, wherein
the service type perception model performs service type perception on all the feature parameters of the service flow based on a plurality of fast gated recurrent units, an output value of the fast gated recurrent unit is calculated based on an update gate and an intermediate state of the fast gated recurrent unit, the intermediate state and the update gate of the fast gated recurrent unit each are calculated based on an output value of a hidden layer of a previous fast gated recurrent unit and a feature parameter input into a current fast gated recurrent unit, and the service type perception model is obtained through training based on a sample feature vector obtained by performing the feature extraction on a sample service flow;
the performing feature extraction on the service flow to obtain a feature vector comprises:
extracting a specified quantity of data packets from the service flow as a service sub-flow; and
performing the feature extraction on the service sub-flow to obtain a feature vector, wherein the feature vector comprises a plurality of feature parameters of the service sub-flow; and
an input value of the fast gated recurrent unit is not a time series parameter, but a feature parameter of the service sub-flow that does not have a temporal sequence characteristic.

2. The service flow perception method for edge computing according to claim 1, wherein the service type perception model comprises an input layer, a fast gated recurrent unit layer, and an output layer;
the fast gated recurrent unit layer comprises a plurality of fast gated recurrent unit groups corresponding to a quantity of feature parameters of the service flow, wherein each fast gated recurrent unit group comprises a plurality of cascaded fast gated recurrent units; and
an intermediate state and an update gate of each fast gated recurrent units each are calculated based on the output value of the hidden layer of the previous fast gated recurrent unit, a feature parameter input into the current fast gated recurrent unit, a weight coefficient of the update gate of the current fast gated recurrent unit, a weight coefficient of the intermediate state of the current fast gated recurrent unit, and an offset.

3. The service flow perception method for edge computing according to claim 2, wherein
the update gate, the intermediate state, and an output value of each fast gated recurrent unit are represented by following formulas:
$$\begin{matrix}{z}_{k} = σ ( {U}_{z} {y}_{k - 1} + {W}_{y} {x}_{k} + {b}_{z} ) ; \\ {y}_{k}^{′} = tanh ( {U}_{z} {y}_{k - 1} + {W}_{y} {x}_{k} + {b}_{z} ) ; \\ {y}_{k} = ( 1 - {z}_{k} ) ⊙ {y}_{k - 1} + {z}_{k} ⊙ {y}_{k}^{′} ;\end{matrix}$$
where yₖ₋₁ represents the output value of the hidden layer of the previous fast gated recurrent unit, xₖ represents the feature parameter that is of the service flow and input into the current fast gated recurrent unit, σ represents a sigmoid function, tanh represents a tanh function, zₖ represents the update gate of the fast gated recurrent unit, y′ₖ represents an updated intermediate state, yₖ represents the output value of the current fast gated recurrent unit, U_{z} represents the weight coefficient of the update gate, W_{y} represents the weight coefficient of the intermediate state, b_{z} represents the offset, and k represents a k^{th} service flow.

4. The service flow perception method for edge computing according to claim 1, wherein the service type perception model is obtained through training based on a following step:
repeatedly performing following steps until a difference between two adjacent output values calculated by the service type perception model is less than a specified threshold:
obtaining the sample service flow;
performing the feature extraction on the sample service flow to obtain the sample feature vector;
inputting the sample feature vector into the service type perception model to obtain a sample service type perception result; and
calculating a difference between the sample service type perception result and an output value previously calculated by the service type perception model; wherein
an output value of the fast gated recurrent unit of the service type perception model after the sample feature vector is continuously input for n times is represented by following formulas:
$$\begin{matrix}{y}_{k + 1}^{( n )} = ( 1 - {z}_{k + 1}^{( n - 1 )} ) ⊙ {y}_{k}^{( n )} + {z}_{k + 1}^{( n - 1 )} ⊙ {y}_{k + 1}^{′ ( n )} ; \\ {y}_{k + 1}^{( 0 )} = 0 ;\end{matrix}$$
where yₖ₊₁⁽ⁿ⁾ represents an output value of the fast gated recurrent unit after a (k+1)^{th} sample feature vector is continuously input for the n times; zₖ₊₁⁽ⁿ⁻¹⁾ represents an update gate of the fast gated recurrent unit after the (k+1)^{th} sample feature vector is continuously input for n−1 times; represents an output value of the fast gated recurrent unit after a k^{th} sample feature vector is continuously input for the n times; y′ₖ₊₁⁽ⁿ⁾ represents an intermediate state of the fast gated recurrent unit after the (k+1)^{th} sample feature vector is continuously input for the n times; and yₖ₊₁⁽⁰⁾ represents an initial output value of the fast gated recurrent unit at a 0^{th} input of the (k+1)^{th} sample feature vector.

5. The service flow perception method for edge computing according to claim 1, wherein the feature parameters comprise at least two of a data amount of a maximum data packet in the service sub-flow, a data amount of a minimum data packet in the service sub-flow, an average data amount of data packets in the service sub-flow, average arrival time of the data packets in the service sub-flow, an average arrival time interval of the data packets in the service sub-flow, a total data amount of the service sub-flow, duration of the service sub-flow, and a flag bit of the service sub-flow.

6. A service flow perception apparatus for edge computing, comprising:
a service access module configured to obtain a service flow;
a service feature extraction module configured to perform feature extraction on the service flow to obtain a feature vector, wherein the feature vector comprises a plurality of feature parameters of the service flow;
a service recognition module configured to input the feature vector into a service type perception model to obtain a service type perception result that is of the service flow and output by the service type perception model; and
a service flow scheduling module configured to allocate a corresponding computing power resource and communication resource to the service flow based on the service type perception result, wherein
the service type perception model performs service type perception on all the feature parameters of the service flow based on a plurality of fast gated recurrent units, an output value of the fast gated recurrent unit is calculated based on an update gate and an intermediate state of the fast gated recurrent unit, the intermediate state and the update gate of the fast gated recurrent unit each are calculated based on an output value of a hidden layer of a previous fast gated recurrent unit and a feature parameter input into a current fast gated recurrent unit, and the service type perception model is obtained through training based on a sample feature vector obtained by performing the feature extraction on a sample service flow;
the performing feature extraction on the service flow to obtain a feature vector comprises:
extracting a specified quantity of data packets from the service flow as a service sub-flow; and
performing the feature extraction on the service sub-flow to obtain a feature vector, wherein the feature vector comprises a plurality of feature parameters of the service sub-flow; and
an input value of the fast gated recurrent unit is not a time series parameter, but a feature parameter of the service sub-flow that does not have a temporal sequence characteristic.

7. The service flow perception apparatus for edge computing according to claim 6, wherein the service type perception model comprises an input layer, a fast gated recurrent unit layer, and an output layer;
the fast gated recurrent unit layer comprises a plurality of fast gated recurrent unit groups corresponding to a quantity of feature parameters of the service flow, wherein each fast gated recurrent unit group comprises a plurality of cascaded fast gated recurrent units; and
an intermediate state and an update gate of each fast gated recurrent units each are calculated based on the output value of the hidden layer of the previous fast gated recurrent unit, a feature parameter input into the current fast gated recurrent unit, a weight coefficient of the update gate of the current fast gated recurrent unit, a weight coefficient of the intermediate state of the current fast gated recurrent unit, and an offset.

8. The service flow perception apparatus for edge computing according to claim 7, wherein the update gate, the intermediate state, and an output value of each fast gated recurrent unit are represented by following formulas:
$$\begin{matrix}{z}_{k} = σ ( {U}_{z} {y}_{k - 1} + {W}_{y} {x}_{k} + {b}_{z} ) ; \\ {y}_{k}^{′} = tanh ( {U}_{z} {y}_{k - 1} + {W}_{y} {x}_{k} + {b}_{z} ) ; \\ {y}_{k} = ( 1 - {z}_{k} ) ⊙ {y}_{k - 1} + {z}_{k} ⊙ {y}_{k}^{′} ;\end{matrix}$$
where yₖ₋₁ represents the output value of the hidden layer of the previous fast gated recurrent unit, xₖ represents the feature parameter that is of the service flow and input into the current fast gated recurrent unit, σ represents a sigmoid function, tanh represents a tanh function, zₖ represents the update gate of the fast gated recurrent unit, y′ₖ represents an updated intermediate state, yₖ represents the output value of the current fast gated recurrent unit, U_{z} represents the weight coefficient of the update gate, W_{y} represents the weight coefficient of the intermediate state, b_{z} represents the offset, and k represents a k^{th} service flow.

9. The service flow perception apparatus for edge computing according to claim 6, further comprising a service perception training module, wherein the service perception training module performs training based on a following step to obtain the service type perception model:
repeatedly performing following steps until a difference between two adjacent output values calculated by the service type perception model is less than a specified threshold:
obtaining the sample service flow;
performing the feature extraction on the sample service flow to obtain the sample feature vector;
inputting the sample feature vector into the service type perception model to obtain a sample service type perception result; and
calculating a difference between the sample service type perception result and an output value previously calculated by the service type perception model; wherein
an output value of the fast gated recurrent unit of the service type perception model after the sample feature vector is continuously input for n times is represented by following formulas:
$$\begin{matrix}{y}_{k + 1}^{( n )} = ( 1 - {z}_{k + 1}^{( n - 1 )} ) ⊙ {y}_{k}^{( n )} + {z}_{k + 1}^{( n - 1 )} ⊙ {y}_{k + 1}^{′ ( n )} ; \\ {y}_{k + 1}^{( 0 )} = 0 ;\end{matrix}$$
where yₖ₊₁⁽ⁿ⁾ represents an output value of the fast gated recurrent unit after a (k+1)^{th} sample feature vector is continuously input for the n times; zₖ₊₁⁽ⁿ⁻¹⁾ represents an update gate of the fast gated recurrent unit after the (k+1)^{th} sample feature vector is continuously input for n−1 times; represents an output value of the fast gated recurrent unit after a k^{th} sample feature vector is continuously input for the n times; y′ₖ₊₁⁽ⁿ⁾ represents an intermediate state of the fast gated recurrent unit after the (k+1)^{th} sample feature vector is continuously input for the n times; and yₖ₊₁⁽⁰⁾ represents an initial output value of the fast gated recurrent unit at a 0^{th} input of the (k+1)^{th} sample feature vector.

10. The service flow perception apparatus for edge computing according to claim 6, wherein the feature parameters comprise at least two of a data amount of a maximum data packet in the service sub-flow, a data amount of a minimum data packet in the service sub-flow, an average data amount of data packets in the service sub-flow, average arrival time of the data packets in the service sub-flow, an average arrival time interval of the data packets in the service sub-flow, a total data amount of the service sub-flow, duration of the service sub-flow, and a flag bit of the service sub-flow.

11. An electronic device, comprising a memory, a processor, and a computer program stored in the memory and operable on the processor, wherein the processor executes the computer program to implement the service flow perception method for edge computing according to claim 1.

12. An electronic device, comprising a memory, a processor, and a computer program stored in the memory and operable on the processor, wherein the processor executes the computer program to implement the service flow perception method for edge computing according to claim 2.

13. An electronic device, comprising a memory, a processor, and a computer program stored in the memory and operable on the processor, wherein the processor executes the computer program to implement the service flow perception method for edge computing according to claim 3.

14. An electronic device, comprising a memory, a processor, and a computer program stored in the memory and operable on the processor, wherein the processor executes the computer program to implement the service flow perception method for edge computing according to claim 4.

15. An electronic device, comprising a memory, a processor, and a computer program stored in the memory and operable on the processor, wherein the processor executes the computer program to implement the service flow perception method for edge computing according to claim 5.

16. A machine-readable storage medium, storing a computer program thereon, wherein the computer program is executed by a processor to implement the service flow perception method for edge computing according to claim 1.

17. A machine-readable storage medium, storing a computer program thereon, wherein the computer program is executed by a processor to implement the service flow perception method for edge computing according to claim 2.

18. A machine-readable storage medium, storing a computer program thereon, wherein the computer program is executed by a processor to implement the service flow perception method for edge computing according to claim 3.

19. A machine-readable storage medium, storing a computer program thereon, wherein the computer program is executed by a processor to implement the service flow perception method for edge computing according to claim 4.

20. A machine-readable storage medium, storing a computer program thereon, wherein the computer program is executed by a processor to implement the service flow perception method for edge computing according to claim 5.
